(19) United States
(12) Patent Application Publication
(10) Pub. No.: US 2006/0109850 A1
(43) Pub. Date: May 25, 2006

(54) IP-SAN network access control list generating method and access control list setup method

(75) Inventors: Toshio Otani, Kawasaki (JP); Naoko Iwami, Sagamihara (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/049,405

(22) Filed: Feb. 1, 2005

(30) Foreign Application Priority Data
Nov. 24, 2004 (JP) 2004-338673

(51) Int. Cl. H04L 12/56

(52) U.S. Cl. 370/395.2; 370/392

(57) ABSTRACT

It is an object of the present invention to realize filter setting peculiar to iSCSI communication on an IP network. In a management server, discovery domain information is acquired, in which the connection relationship between a TCP port number and an IP address allocated to an iSCSI node, whether the iSCSI node is an iSCSI initiator or an iSCSI target, and a group to which the iSCSI node belongs are described. For a set of iSCSI nodes belonging to the same group, an access control list in which the IP address of the iSCSI node which is the iSCSI initiator is a source and in which the TCP port number and the IP address of the iSCSI node which is the iSCSI target is a destination is generated and then is set in a communication device.

### CROSS-REFERENCES TO RELATED APPLICATION

This application relates to and claims priority from Japanese Patent Application No. 2004-338673, filed on Nov. 24, 2004, the entire disclosure of which is incorporated herein by reference.

### BACKGROUND OF THE INVENTION

1. Field of the Invention

The present invention relates to a security policy technique in an IP-SAN, and more particularly to a filter technique on an IP network, in which restrictions related to iSCSI are reflected.

2. Description of the Related Art

In recent years, IP-SAN (Storage Area Network) by iSCSI (Internet Small Computer Interface) has come into wide use in which a storage device and a host are connected to an IP (Internet Protocol) and data can be read/write between the host and a Volume of the storage device. In the IP-SAN by the iSCSI, devices constituting the IP-SAN, such as a storage device and a host, are called iSCSI nodes. One of the iSCSI nodes outputting an SCSI command is called an iSCSI initiator, and another one for executing the SCSI command is called an iSCSI target. In communication by an iSCSI protocol between the iSCSI nodes (hereinafter, referred to as ‘iSCSI communication’), connection from an iSCSI initiator to an iSCSI target is performed. Therefore, the connection between the iSCSI initiators, the connection between the iSCSI targets, and connection from the iSCSI target to the iSCSI initiator are not permitted.

Since IP-SAN is operated on the IP network, it is exposed to various attack means considered on the IP network. That is, the attack means are placed at various positions, compared to FC-SAN by a fibre channel protocol. Therefore, IP-SAN needs a security policy for protecting itself against various attack means, and thus various methods are considered as the security policy in IP-SAN.

For example, certification is performed using a password at the time of login to restrict access, thereby improving security. In this method, when the iSCSI initiator transmits a connection request to the iSCSI target, the iSCSI target authenticates the iSCSI initiator (authentication by a user name and a password, which is called iSCSI log-in authentication) (for example, see Non-patent Document 1).

Further, there is a method of ensuring security by restricting a discovery range using an iSNS (Internet Storage Name Service) method.

Each iSCSI node has an iSCSI name for identifying or managing the node. In order for the iSCSI initiator to establish an iSCSI session to the iSCSI target, an IP address, a TCP port number, and an iSCSI name of the target are needed. An iSNS server manages these information items. In addition, an iSNS server also manages a group to which the iSCSI nodes belongs, which is called ‘DD’ (Discovery Domain). DD is a group of iSCSI nodes capable of communication, and communication is permitted between only the iSCSI nodes belonging to the same DD.

When receiving an inquiry about the iSCSI node capable of communication from an iSCSI node, which is the iSCSI initiator, the iSNS server transmits information necessary for connection, such as the IP address and TCP number of the iSCSI target belonging to the same DD group as the iSCSI node, which is an inquiry source, in response to the inquiry. This method in which an iSCSI node inquires of the iSNS server about a connectable iSCSI node and immediately acquires information necessary for connection, such as the IP address, is called ‘discovery’.

As such, DD restricts the range of discovery. For example, when an iSCSI node NA belonging to a DD group A performs discovery, the iSCSI node NA can get only information on the iSCSI node belonging to the DD group A, and the iSCSI node NA cannot get information on the iSCSI node belonging to a DD group B. Therefore, the iSCSI node NA can communicate with only the iSCSI node belonging to the DD group A.

There has been proposed a technique of restricting iSCSI communication by providing the above-mentioned discovery function using the iSNS server (for example, see Non-patent Document 2).

[Non-patent Document 1] J. Satran, ‘RFC3720 Internet Small Computer Systems Interface (iSCSI)’, IETF, 2004; http://www.ietf.org/rfc/rfc3720.txt

[Non-patent Document 2] Josh Tseng, ‘Internet Draft <draft-ietf-ips-isns-22.txt> Internet Storage Name Service (iSNS)’, IETF, 2004; http://www.ietf.org/internet-drafts/draft-ietf-ips-isns-22.txt

As such, the iSCSI communication is characterized in that connection is permitted only from the iSCSI initiator to the iSCSI target, and that the connection between the iSCSI initiators, the connection between the iSCSI targets, connection from the iSCSI target to the iSCSI initiator are not permitted.

However, the types of iSCSI, such as the iSCSI initiator and the iSCSI target, are information peculiar to an iSCSI layer, and an IP layer in which the IP network is constructed does not mean information thereof. Therefore, there is a possibility that, in the IP layer, an IP packet, which is a pattern not permitted in the iSCSI layer, will reach the iSCSI node.

For example, according to the discovery using the iSNS server, a connectable iSCSI node responds, and thus communication is performed only between the connectable iSCSI nodes. However, an IP packet is not physically interrupted. Therefore, when the IP address of the iSCSI node to which access is not permitted is acquired by an illicit means at the time of discovery, there is a possibility that the communication between apparatuses will be performed without permission.

Since the authentication of the iSCSI node and the discovery restriction by the DD are performed in the iSCSI layer positioned higher than the IP layer, the above-mentioned techniques cannot interrupt an unauthorized IP packet transmitted in the IP layer. Therefore, when an IP address of an attack target is known, it is possible to transmit the IP packet to an iSCSI node that is not permitted in the iSCSI layer, using an IP address Scan technique. Therefore, there is a problem in that an attack can be made using the weakness of the iSCSI and an unnecessary TCP Open port by communication other than the above-mentioned communication.

That is, in the conventional technique, various security policy means are provided in the iSCSI layer higher than the IP layer, but no security policy means is provided in the IP layer. Therefore, the communication between the iSCSI nodes that is not authenticated in the iSCSI layer cannot be prevented in the IP layer. It is difficult to defend various attacks considered in the IP network, such as an attack against IP-SAN by illicit communication in the iSCSI layer, for example, unrestricted access to LU (Logical Unit) by connection to an iSCSI target that is not permitted access, an attack against a port for managing the iSCSI target, an attack against an additional iSCSI initiator using the iSCSI initiator as a step stone, an attack against an illicit TCP Open port, a wiretap by the misrepresentation of a MAC address, and an illicit DoS attack.

### SUMMARY OF THE INVENTION

Accordingly, the invention is designed to solve the above-mentioned problems, and it is an object of the invention to restrict illicit communication not permitted in iSCSI communication at an IP level to improve the security level of IP-SAN.

In order to achieve the above object, the invention provides a means for realizing filter setting on an IP network, in which restrictions peculiar to iSCSI communication are reflected. In addition, the invention provides a means for generating an access control list in an IP layer from connection information peculiar to an iSCSI layer (DD information, storage path definition, etc.).

Specifically, the invention provides a method of generating an access control list (ACL) for filtering, in each communication device, IP packets transmitted/received between iSCSI (Internet Small Computer Interface) nodes in a storage area network in which iSCSI communication between the iSCSI nodes is restricted within predetermined groups, the storage area network having iSCSI node groups each connected to an IP network through the communication device to perform the iSCSI communication, the method comprising: a step of acquiring management information for managing by associating, for every iSCSI node, a type of an iSCSI node indicating whether the iSCSI node is an initiator or a target, an IP address and a port number allocated to the iSCSI node, and an identifier of the group to which the iSCSI node belongs; and a step of generating, for every group, an ACL in which the IP address of an iSCSI node whose type is the iSCSI initiator is a source IP address and in which the IP address and port number of another iSCSI node whose type is the iSCSI target are a destination IP address and a destination port number.

Therefore, according to the invention, it is possible to restrict unnecessary IP communication between iSCSI nodes, and thus the security level of IP-SAN can be improved.

### BRIEF DESCRIPTION OF THE DRAWINGS

FIG. 1 is a system block diagram of a first embodiment.

FIG. 2 is a block diagram of a host according to the first embodiment.

FIG. 3 is a block diagram of a storage device according to the first embodiment.

FIG. 4 is a block diagram of an iSNS server according to the first embodiment.

FIG. 5 is a view illustrating an example of DD data according to the first embodiment.

FIG. 6 is a block diagram of a communication device according to the first embodiment.

FIG. 7 is a view illustrating an example of a MAC table stored in the communication device according to the first embodiment.

FIG. 8 is a view illustrating an example of the MAC table stored in the communication device according to the first embodiment.

FIG. 9 is a view illustrating an example of Config information held in the communication device according to the first embodiment.

FIG. 10 is a view illustrating an example of the Config information held in the communication device according to the first embodiment.

FIG. 11 is a block diagram of a management server according to the first embodiment.

FIG. 12 is a view illustrating an example of an ACL table according to the first embodiment.

FIG. 13 is a view illustrating an example of ACL log data according to the first embodiment.

FIG. 14 is a flow chart illustrating a process executed by an ACL generating program according to the first embodiment.

FIG. 15 is a view illustrating an example of a temporary ACL table according to the first embodiment.

FIG. 16 is a view illustrating an example of the ACL table generated while the ACL generating program is being executed according to the first embodiment.

FIG. 17 is a view illustrating an example of the temporary ACL table according to the first embodiment.

FIG. 18 is a flow chart illustrating a process executed by an ACL setup program according to the first embodiment.

FIG. 19 is a flow chart illustrating an ACL generating process A according to the first embodiment.

FIG. 20 is a flow chart illustrating an ACL generating process B according to the first embodiment.

FIG. 21 is a view illustrating an example of the Config information according to the first embodiment.

FIG. 22 is a view illustrating an example of the Config information according to the first embodiment.

FIG. 23 is a flow chart illustrating a process executed by an ACL generating program according to a second embodiment.

FIG. 24 is a view illustrating an example of an ACL table according to the second embodiment.

FIG. 25 is a view illustrating an example of Config information according to the second embodiment.

FIG. 26 is a view illustrating an example of the Config information according to the second embodiment.

FIG. 27 is a system block diagram of a third embodiment.

FIG. 28 is a view illustrating an example of path definition according to the third embodiment.

FIG. 29 is a flow chart illustrating a process executed by an ACL generating program according to the third embodiment.

### DESCRIPTION OF THE PREFERRED EMBODIMENTS

### First Embodiment

Hereinafter, a first embodiment of the invention will be described with reference to the accompanying drawings.

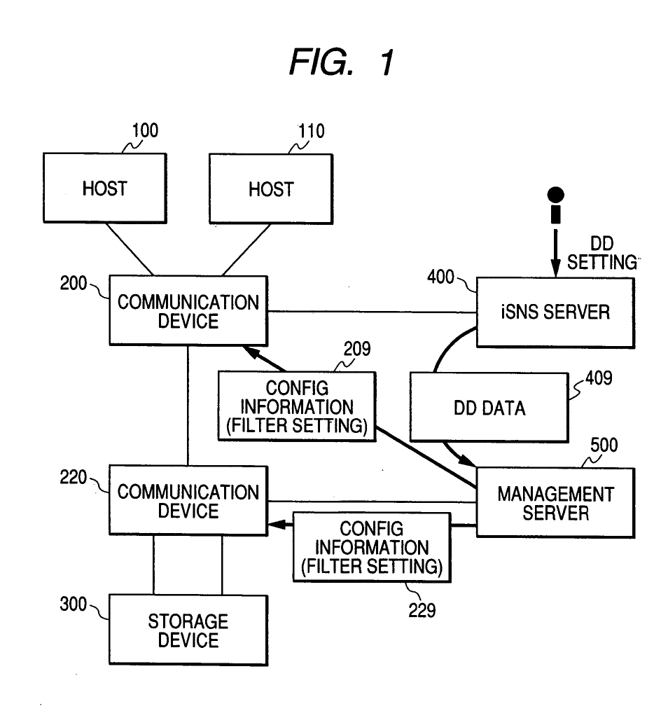

FIG. 1 is a block diagram illustrating the overall structure of a storage area network according to the present embodiment. As shown in FIG. 1, the storage area network of the present embodiment is an IP-SAN system in which various constituent nodes are connected to each other through an IP network, and the constituent nodes include hosts 100 and 110, communication devices 200 and 220, a storage device 300, an iSNS server 400, and a management server 500. Further, the number of various constituent nodes including the storage device is not limited thereto. The various constituent nodes will be described below in detail.

First, the hosts 100 and 110 will be described. The hosts 100 and 110 have the same structure and perform the same function. Therefore, the host 100 will be described as an example.

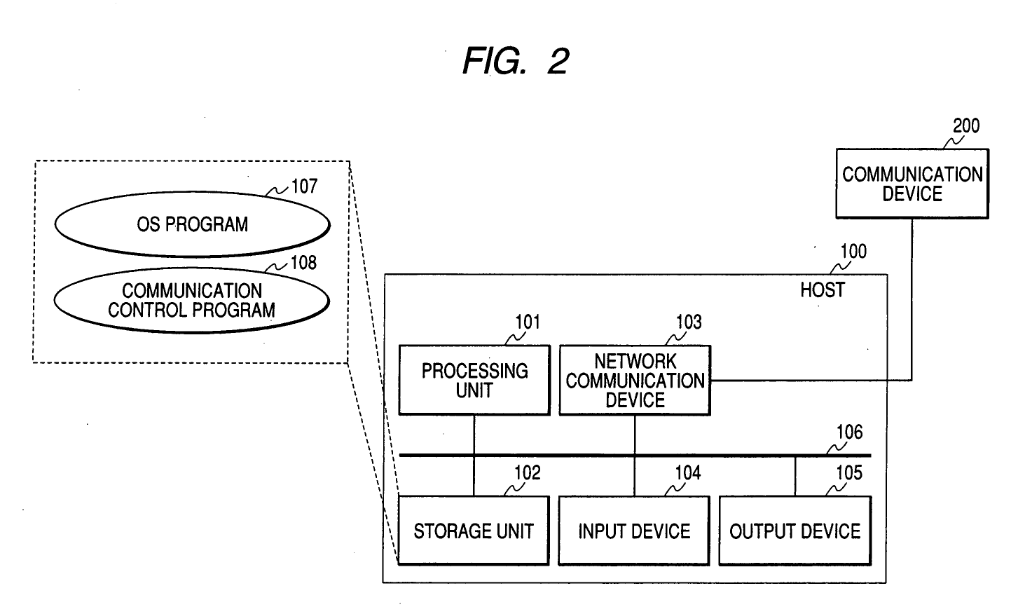

FIG. 2 is a view illustrating the structure of the host 100. The host 100 has a processing unit 101 composed of a CPU, etc., a storage unit 102 composed of a storage device, such as a RAM, a network communication device 103, an input device 104 for performing an input process through an input device, such as a keyboard, an output device 105 for outputting data to an output device, such as a display, and a bus 106 for connecting the above-mentioned components.

The storage unit 102 is stored with an OS program 107 for realizing a memory managing function or a task managing function and a communication control program 108 for realizing a communication processing function with a storage device 300, which will be described later. These programs are executed by the CPU of the processing unit 101 to realize the respective functions.

The network communication device 103 is an interface for connection with the communication device 200 and physically connects the host 100 with the communication device 200 to perform a communication process of a network layer related to the host 100 in a communication protocol supplied by the communication device 200. In the present embodiment, the communication protocol is referred to as an IP.

Further, the host 100, in the upper layer via the communication device 200, communicates with the storage device 300 according to an iSCSI protocol. The data communication control program 108 performs a process related to the communication (iSCSI communication) by the iSCSI protocol. The communication control program 108 allows the host 100 to be operated as an iSCSI initiator. Hereinafter, the iSCSI name of the iSCSI initiator realized in the host 100 is referred to as ‘iqn.a.com:hst-A’.

Furthermore, similar to the host 100, the host 110 is also operated as the iSCSI initiator and performs the iSCSI communication with the storage device 300. Hereinafter, the iSCSI name of the iSCSI initiator realized in the host 110 is referred to as ‘iqn.a.com:hst-B’.

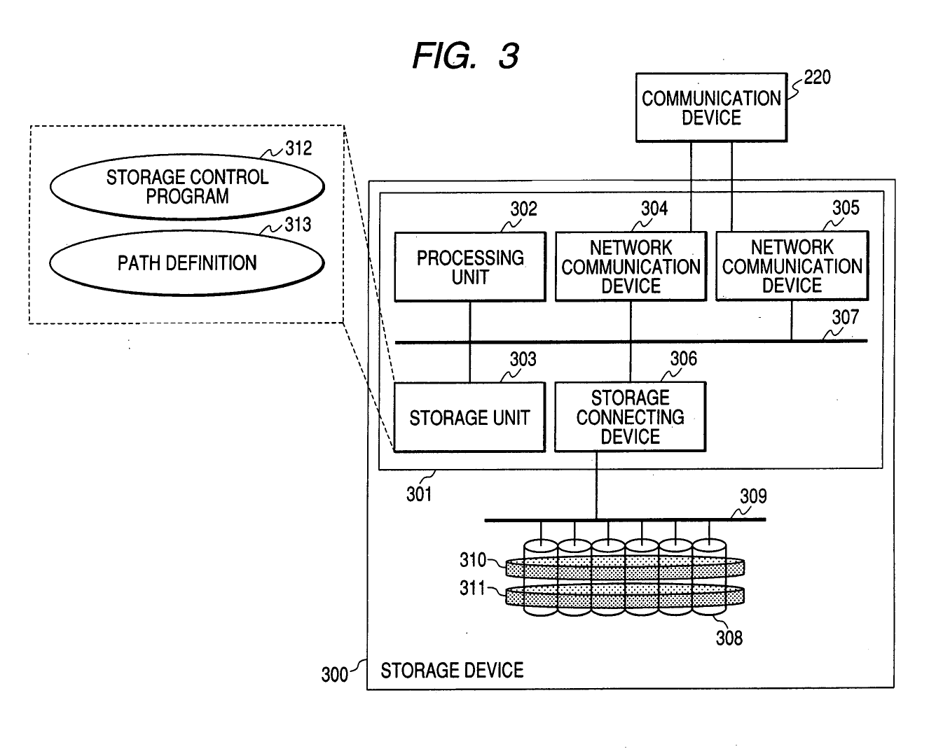

Next, the storage device 300 will be described. FIG. 3 is a view illustrating the structure of the storage device 300.

In FIG. 3, the storage device 300 is stored with a storage control device 301 for performing the overall control of the storage device 300, a physical disk group 308, and a bus 309 for connecting the storage control device 301 with the physical disk group 308.

The physical disk group 308 is composed of logical storages (LU (Logical Unit), and hereinafter referred to as volume) 310 and 311 that are obtained by partially combining data storing areas and to which data is actually stored. It goes without saying that the number of logical units is not limited thereto.

The storage control device 301 has a processing unit 302 composed of a CPU, etc., a storage unit 303 composed of a storage device, such as a RAM, network communication devices 304 and 305, a storage connecting device 306, and a bus 307 for connecting the respective components.

The storage unit 303 is stored with a storage control program 312 for performing management on access to volumes 310 and 311 and a path definition 313. The path definition is a table for managing the correspondence between the iSCSI initiator and a volume to which the iSCSI initiator can be connected.

The storage device 300 communicates with the hosts 100 and 110 via the communication device 220 according to the iSCSI protocol. A storage control program 312 is executed by the CPU of the processing unit 302 to perform a process related to the iSCSI communication. In addition, the storage control program 312 allows the storage device 300 to be operated as an iSCSI target for every volume. Hereinafter, the iSCSI name of the iSCSI target corresponding to the volume 310 among the iSCSI targets realized in the storage device 300 is referred to as ‘iqn.a.com:str-LU0’, and the iSCSI name of the iSCSI target corresponding to the volume 311 is referred to as ‘iqn.a.com:str-LU1’. In addition, the correspondence is not limited thereto.

The network communication devices 304 and 305 are connection interfaces between the storage device 300 and the communication device 220. The storage device 300 is physically connected to the communication device 220 through the network communication devices 304 and 305, and perform a communication process of a network layer related to the storage device 300 in a communication protocol (an IP in the present embodiment) supplied by the communication device 220.

The storage connecting device 306 is an interface for connection with the physical disk group 308.

Next, the iSNS server 400 will be described. As described above, the iSNS server 400 receives a discovery from each iSCSI node and responds thereto.

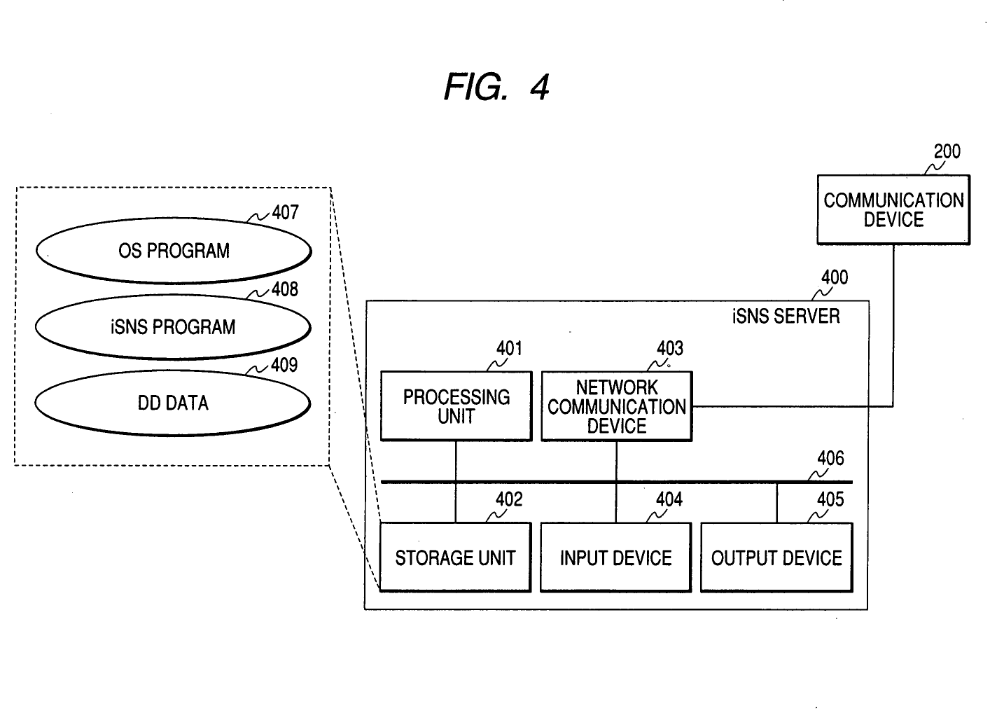

FIG. 4 is a view illustrating the functional structure of the iSNS server 400. As shown in FIG. 4, the iSNS server 400 has a processing unit 401 composed of a CPU, etc., a storage unit 402 composed of a storage device, such as a RAM, a network communication device 403, an input device 404 for performing an input process through an input device, such as a keyboard, an output device 405 for outputting data to an output device, such as a display, and a bus 406 for connecting the above-mentioned components.

The storage unit 402 is stored with an OS program 407 for performing memory management and task management, an iSNS program 408 for realizing an iSNS function of responding to an inquiry by the iSCSI name, and DD (Discovery Domain) data 409 for managing the correspondence between the iSCSI name and an IP address.

The network communication device 403 is an interface for connection with the communication device 200, and connects the iSNS server 400 to the communication device 200 to perform the communication process of the network layer related to the iSNS server 400 according to a communication protocol (an IP in the present embodiment) supplied by the communication device 200.

When receiving a discovery request from the iSCSI initiator, an iSNS program 408 retrieves the DD data 409 and transmits the iSCSI name, IP address, and TCP port number of an iSCSI target belonging to the same DD as the iSCSI initiator of a request source to the iSCSI initiator of the request source in response to the discovery request.

The DD data 409 is a table for managing the information of each iSCSI node to perform a response corresponding to the discovery. The DD data 409 manages the iSCSI name of each iSCSI node, the type of the iSCSI node (an initiator or a target), the group to which the iSCSI node belongs, and the IP address of the iSCSI node so as to correspond to each other. In addition, when the type of the iSCSI node is an iSCSI target, the DD data 409 is also stored with a TCP port number waiting for the iSCSI communication.

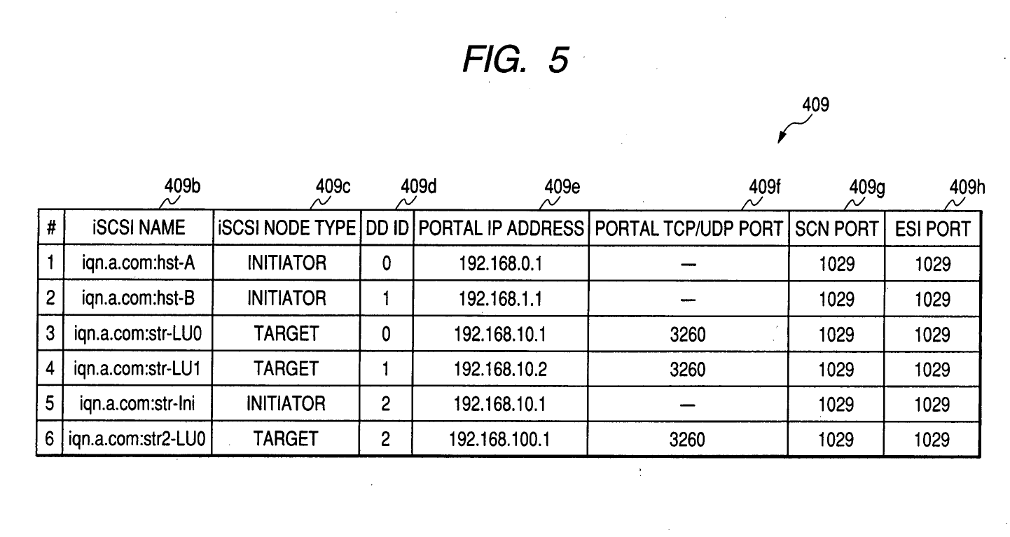

FIG. 5 shows an example of the DD data 409 of the present embodiment. As shown in FIG. 5, the DD data 409 is stored with attribute information, such as an iSCSI Name 409b, an iSCSI Node Type (which indicates the iSCSI initiator and the iSCSI target in the present embodiment) 409c, a DD ID (an ID for identifying the group of DD) 409d, a Portal IP Address (an IP address for realizing the communication between the iSCSI nodes) 409e, a Portal TCP/UDP Port (a TCP port number which the iSCSI target waits for) 409f, an SCN port (which will be described later) 409g, and an ESI Port (which will be described later) 409h, for every iSCSI node.

In FIG. 5, for example, as shown in a first row of records, the iSCSI name of the iSCSI node is ‘iqn.a.com:hst-A’, the iSCSI node type thereof is an iSCSI initiator, the iSCSI node belongs to a group whose DD ID is zero, and the IP address of the iSCSI node is ‘192.168.0.1’. Further, as shown in a third row of records, the iSCSI name of the iSCSI node is ‘iqn.a.com:str-LU0’, the iSCSI node type thereof is a target, the iSCSI node belonging to a group whose DD ID is zero, the IP address of the iSCSI node is ‘192.168.10.1’, and a TCP port number used in the iSCSI communication is 3260.

In this case, an initiator (the host 100) whose iSCSI name is ‘iqn.a.com:hst-A’ can read/write data from/to the volume 310 through ‘iqn.a.com:str-LU0’ belonging to the same group whose DD ID is zero, and an initiator (the host 110) whose iSCSI name is ‘iqn.a.com:hst-B’ can read/write data from/to the volume 311 through ‘iqn.a.com:str-LU1’ belonging to the same group whose DD ID is ‘1’.

When the iSCSI initiator whose iSCSI name is ‘iqn.a.com:hst-A’ performs discovery on the iSNS server 400, the iSNS server 400 retrieves the DD data 409 according to the iSNS program 408 and transmits information in the third row of records having the same DD ID as ‘iqn.a.com:hst-A’ in response to the discovery request. In this way, the iSNS server 400 provides a discovery function using DD to restrict the unauthorized iSCSI communication at an iSCSI layer level.

Further, the DD data 409 is created by, for example, the following method. The DD ID and the iSCSI name belonging to the DD is registered by an administrator of the present system as a packet which is called ‘DDReg’ transmitted from a user terminal (not shown) used by the administrator. The necessary attributes, such as the iSCSI Name and Portal IP Address, are registered on the iSNS server 400 as a packet that is called ‘DevAttrReg’ at the timing when each iSCSI node is connected to the communication device, which can be realized by the conventional iSNS technique. The iSNS server 400 may directly receive the iSCI Name from the administrator.

Next, the communication devices 200 and 220 will be described. The communication devices 200 and 220 have the same structure and realize the same function. Therefore, the communication device 200 is described as a representative example.

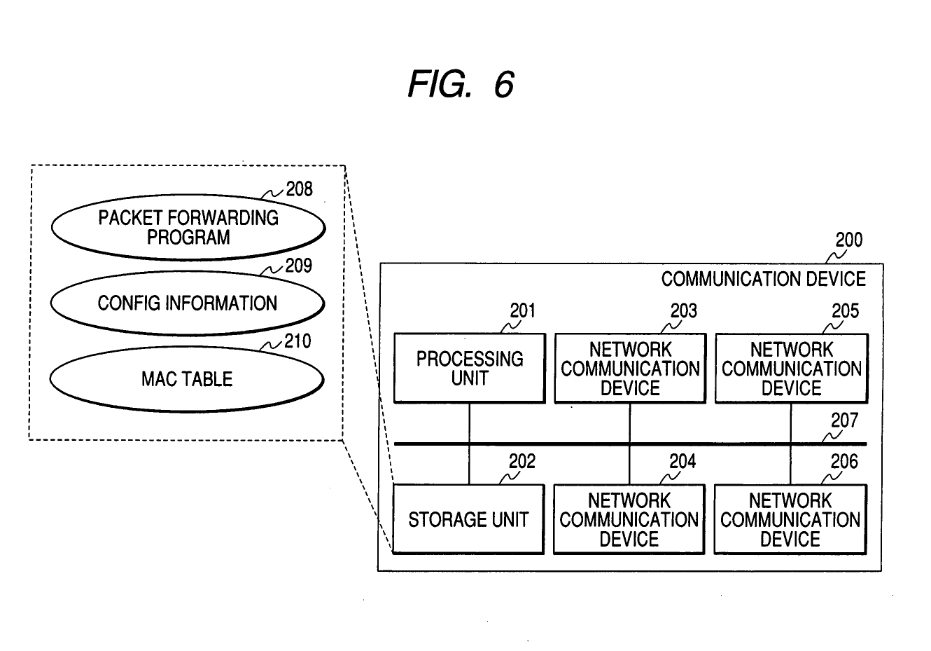

FIG. 6 is a view illustrating the structure of the communication device 200. The communication device 200 has a processing unit 201 composed of a CPU, etc., a storage unit 202 composed of a storage device, such as a RAM, network communication devices 203, 204, 205, and 206, and a bus 207 for connecting the above-mentioned components.

The storage unit 202 is stored with a packet forwarding program 208 for performing a packet transmitting process according to an IP protocol, Config information 209, and a MAC table 210. The packet forwarding program 208 is executed by the CPU of the processing unit 201 to realize the function thereof.

The network communication devices 203, 204, 205, and 206 are physically connected to the hosts 100 and 110, the iSNS server 400, and the communication device 220, respectively, and performs the packet transmitting process by the packet forwarding program 208 according to the IP protocol.

The MAC table 210 is a table for managing the correspondence between an IP address and a MAC (Media Access Control) address and gives an interface name to each of them. The interface name is used for the description of the Config information 209 which will be described later. The MAC table 210 is automatically collected by, for example, an ARP (Address Resolution Protocol) and is stored in a format related to the interface name.

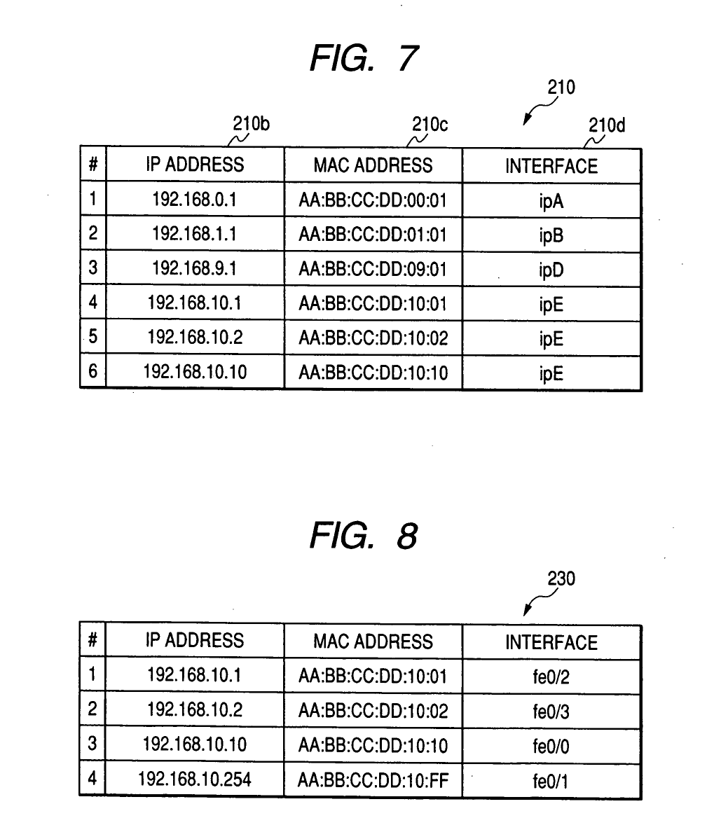

FIG. 7 shows an example of the MAC table 210 stored in the communication device 200 connected to the hosts 100 and 110. Further, FIG. 8 shows an example of a MAC table 230 stored in the communication device 220 connected to the storage device 300. As shown in FIG. 7, the MAC table 210 is stored with MAC addresses 210c and interface names 210d corresponding to each IP address 210b.

The Config information 209 includes information on the setting of packet transmission or packet filtering (ACL (Access Control List)) for each interface of the communication device, and is previously set up through the user terminal (not shown) by the administrator. In addition, in the present specification, hereinafter, the description of a set of a source IP address (and a TCP port number) and a destination IP address (and a TCP port number) of the IP packet capable of passing through the communication device is referred to as an ‘ACL’. The communication device passes only an IP packet satisfying the ACL.

Further, in the present embodiment, the Config information 209 once set is updated by an ACL setup program 509 of a management server 500 which will be described later.

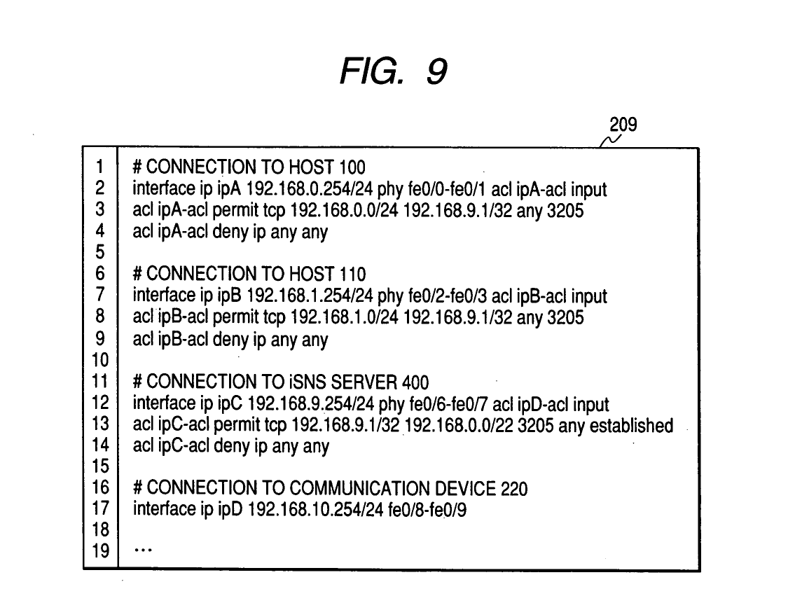

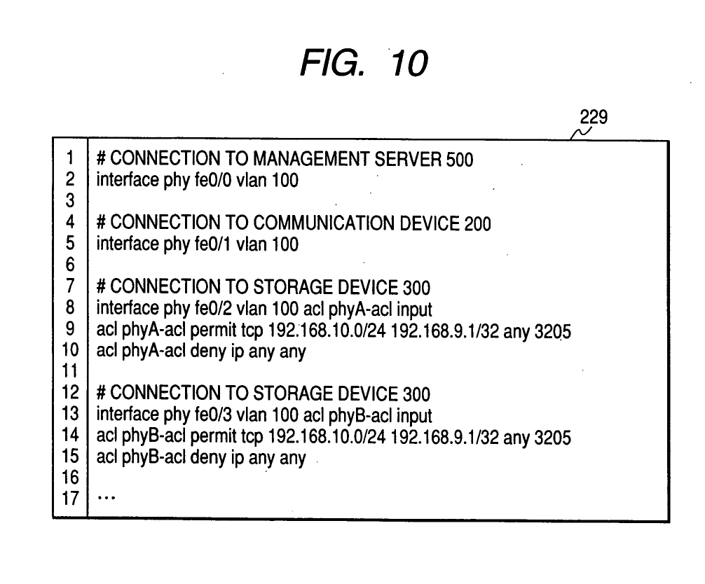

FIG. 9 shows an example of the Config information 209 stored in the communication device 200 connected to the hosts 100 and 110. Further, FIG. 10 shows an example of Config information 229 stored in the communication device 220 connected to the storage device 300.

In the Config information 209 shown in FIG. 9, the setup of an interface connected to the host 100 is described in the first to fourth rows. The second row describes that a logical interface ipA has an IP address of 192.168.0.254/24, physical ports fe0/0 to fe0/1 are allocated, and an access control list ipA-acl is set in the input (a packet transmitted from the host 100 to the communication device 200) direction.

Further, the detailed setup contents of the access control list ipA-acl are described in the third and fourth rows. That is, as the access control list ipA-acl, an access control list is set to permit the communication of data having a source IP address of ‘192.168.0.0/24’, a source TCP port of ‘any’, a destination IP address of ‘192.168.9.1/32’ (which indicates an IP address of the iSNS server 400), and a destination TCP port number of 3205 and not to permit the communication of data other than the above-mentioned data.

Furthermore, the term ‘established’ described in the thirteenth row of the Config information 209 indicates that a response to connection where SYN of TCP (a connection start requesting packet) is transmitted is permitted. This is generally used to permit stable communication in the TCP.

Moreover, as shown in the Config information 209, the communication device 200 accommodates a plurality of interfaces having different subnets to perform IP routing inside the communication device 200.

Further, the physical interfaces fe0/0, fe0/1, fe0/2, and fe0/3 belong to the same VLAN (Virtual LAN; the same subnet) according to the Config information 229 of the communication device 220 shown in FIG. 10.

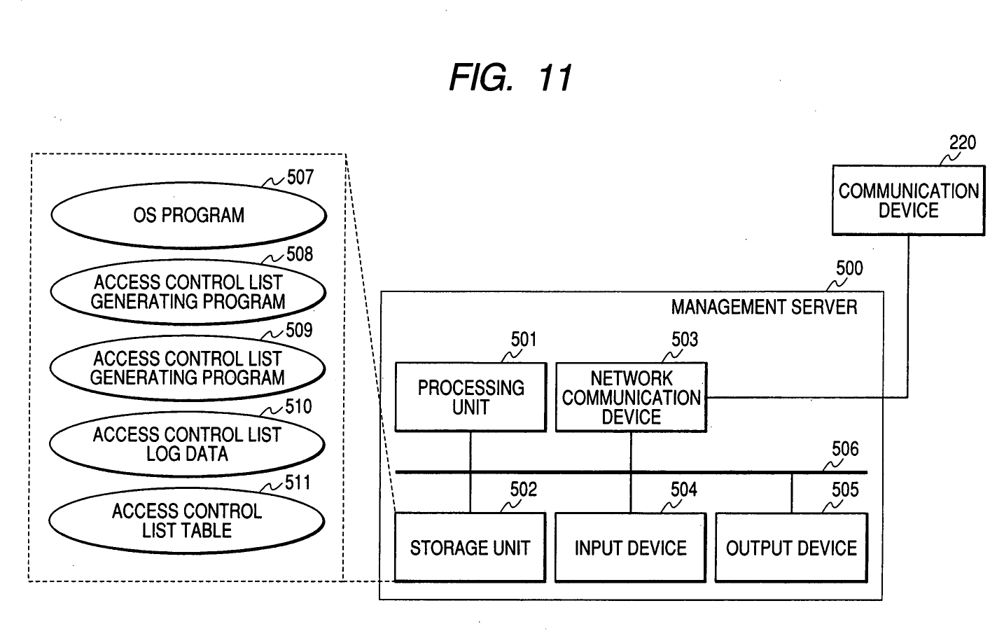

Next, the management server will be described. FIG. 11 is a view illustrating the structure of the management server 500. As shown in FIG. 11, the management server 500 has a processing unit 501 composed of a CPU, etc., a storage unit 502 composed of a storage device, such as a RAM, a network communication device 503, an input device 504 for performing an input process through an input device, such as a keyboard, an output device 505 for outputting data to an output device, such as a display, and a bus 506 for connecting the above-mentioned components.

The storage unit 502 is stored with an ACL table 511, an OS program 507 for performing memory management and task management, an ACL generating program 508, an ACL setup program 509, and ACL log data 510 for managing ACL log data, which will be described later.

The network communication device 503 is an interface for connection with the communication devices 220 and physically connects the management server 500 to the communication devices 220 to perform the communication process of a network layer related to the management server 500 according to a communication protocol (IP in the present embodiment) supplied by the communication devices 220.

The ACL generating program 508 generates an ACL in an IP layer corresponding to communication permitted in an iSCSI layer based on the DD data 409 stored in the iSNS server 400 and stores it in an ACL table 511. That is, the ACL generating program 508 generates an ACL in which the source indicates an IP address of an iSCSI initiator and the destination indicates a TCP port number and an IP address of an iSCSI target in IP communication, and stores the ACL in the ACL table 511.

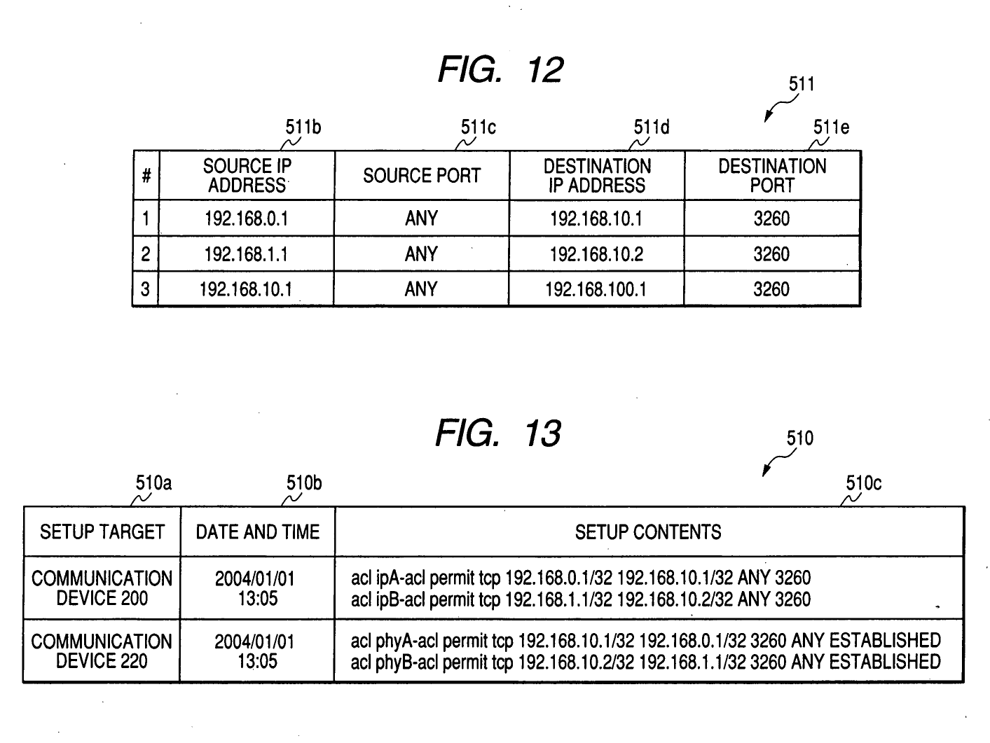

The ACL table 511 is stored with IP addresses and TCP port numbers of the iSCSI initiator and iSCSI target whose communication is permitted in the iSCSI layer as one record. FIG. 12 shows an example of the ACL table 511.

As shown in FIG. 12, the ACL table 511 has a source IP address 511b, which is an IP address of an iSCSI node of the source, a source port 511c corresponding to the source IP address 511b, and a destination IP address 511d and a destination port 51e respectively serving as an IP address and a TCP port number of the iSCSI node where communication is permitted.

The ACL setup program 509 makes a description capable of being registered on the Config information from the ACL stored in the ACL table 511 and additionally sets the ACL to the Config information items 209 and 229 of the communication devices 200 and 220.

Further, the ACL log data 510 stores the log of the ACL added to the Config information items of the communication devices 200 and 220 by the ACL setup program 509. FIG. 13 shows an example of the ACL log data 510. The ACL log data 510 is used when removing unnecessary ACLs, as will be described later.

As shown in FIG. 13, the ACL log data 510 has a setup target 510a, data and time 510b, and setup contents 510c. The name of a communication device having the present record set in the Config information is stored as the setup target 510a, and the data and time when the present record is set in the communication device are stored as the date and time 510b.

According to the above-mentioned structure, the hosts 100 and 110, the storage device 300, the iSNS server 400, and the management server 500 realize communication between each of them, which is permitted in the iSCSI layer, according to the IP protocol.

Next, a procedure of generating the ACL table 511 by the ACL generating program 508 will be described. The procedure is performed as follows.

When the DD data 409 is changed, the management server 500 acquires the changed DD data 409 from the iSNS server 400 through the communication devices 200 and 220.

Then, the management server 500 generates the ACL table 511 in which a source is an IP address of an iSCSI initiator and a destination is a TCP port number and an IP address of an iSCSI target for every iSCSI node having the same DD ID, with reference to the acquired DD data 409, according to the ACL generating program 508.

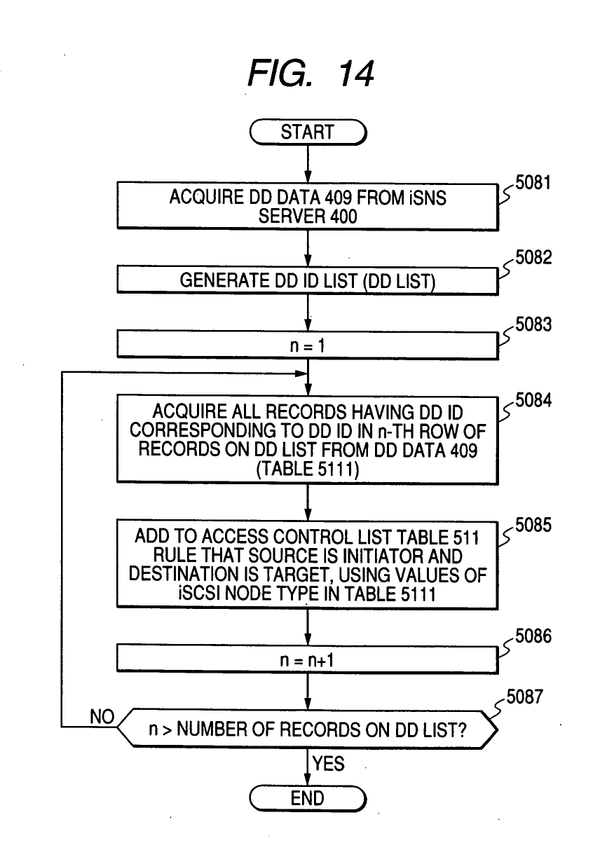

Hereinafter, a process flow of the ACL generating program 508 will be described in detail. FIG. 14 shows a process flow at the time when the ACL table 511 is generated by the ACL generating program 508. In the following description, the DD data 409 shown in FIG. 5 is described as an example.

The ACL generating program 508 receives a message indicating that the DD data 409 has been updated and the updated DD data 409 from the iSNS server 400 (step 5081). The DD data 409 can be acquired using a conventional technique, such as SNMP Trap. That is, the DD data 409 is acquired at a point of time when the registration of an attribute by DevAttrReg from the iSCSI node is completed. For example, when the attribute registration is completed, the iSNS server 400 transmits the SNMP Trap to the management server 500. Then, the management server 500 waits for the SNMP Trap all the time and then performs the above-mention process at the timing when the SNMP Trap is received.

Subsequently, the ACL generating program 508 generates an ACL for every record having the same DD ID and registers it in the ACL table 511. Specifically, the ACL generating program 508 performs the following process.

The ACL generating program 508 reads out all DD IDs included in the acquired DD data 409, and generates a DD ID list (hereinafter, referred to as a DD list), removing duplicate DD IDs from all DD IDs. Then, the ACL generating program 508 counts the number of records in the DD list and stores it (step 5082). In the DD data 409 shown in FIG. 5, the DD list is composed of ‘0, 1, and 2’. The number of records is three.

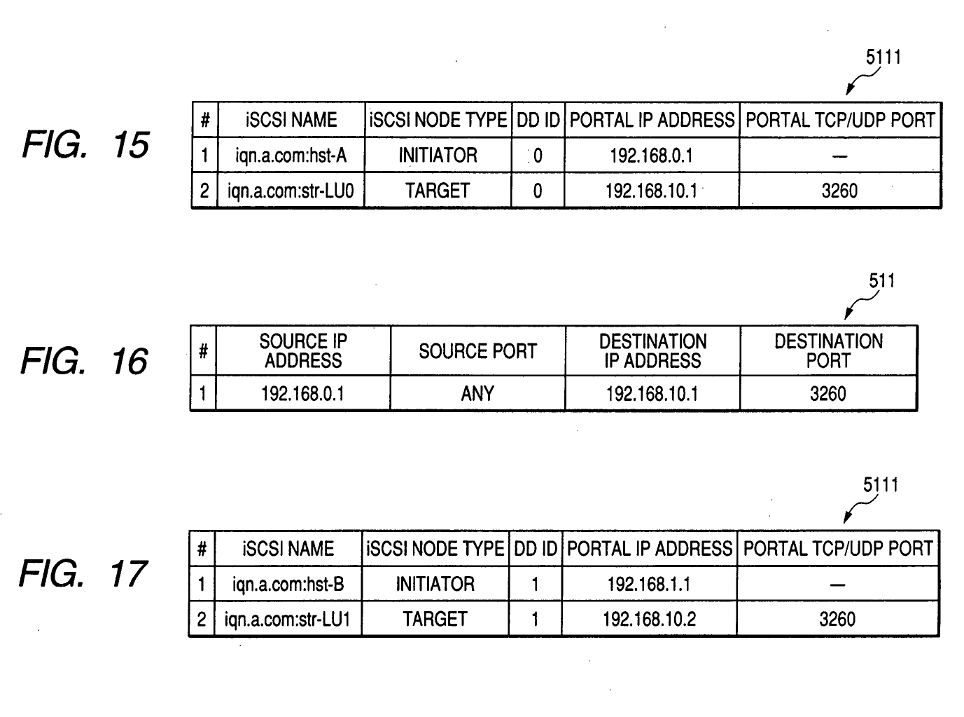

The ACL generating program 508 sets ‘n’ (where n is a natural number) to 1 (step 5083). Then, the ACL generating program 508 acquires all records having a DD ID corresponding to the DD ID of an n-th row of record on the DD list from the DD data 409 and stores them in a temporary ACL table 5111 temporarily generated in the storage unit 502 (step 5084). In the case that the DD list is generated in the order of 0, 1, and 2 from the first row and the DD data 409 is as shown in FIG. 5, when n=1, a record whose DD ID is zero is extracted from the DD data 409. An example of the temporary ACL table 5111 generated at that time is shown in FIG. 15. In the present embodiment, an attribute such as SCN Port is omitted.

The ACL generating program 508 generates a record in which the source IP address 511b is an IP address of the iSCSI initiator, the destination IP address 511d is an IP address of the iSCSI target, and the destination port 511e is a TCP/UDP port of the iSCSI target, using the data stored in the temporary ACL table 5111, and adds the record to the ACL table 511 (step 5085).

In this case, first, the ACL generating program 508 recognizes Portal IP Address of the record in which iSCSI Node Type is Initiator in the temporary ACL table 5111 as an IP address of the source. For example, instead of being recognizing as the iSCSI Node Type, since the field Portal TCP/UDP Port is blank, it may be recognized that the iSCSI node indicated by the record is the Initiator, that is, the Portal IP Address of the record may be recognized as the IP address of the source.

Further, the ACL generating program 508 recognizes the Portal IP Address and Portal TCP/UDP Port of the record in which the iSCSI Node Type is Target as an IP address and a TCP port number of the source. In this case, instead of being recognizing as the iSCSI Node Type, since the field Portal TCP/UDP Port is blank, it may be recognized that the iSCSI node indicated by the record is Target.

Furthermore, when a plurality of the iSCSI Initiators and/or the iSCSI Targets belongs to the same DD ID, the ACL is generated for all sets of the iSCSI Initiator and the iSCSI Target.

The ACL table 511 generated at that time is shown in FIG. 16. As shown in FIG. 16, contents indicated in the first row of the temporary ACL table 5111 shown in FIG. 15 are stored in the ACL table 511 as an IP address of the source, and a record stored with contents shown in the second row are additionally stored therein as a destination IP address and a destination port. That is, it is possible to generate an ACL in which a source indicates an IP address of the iSCSI Initiator and a destination indicates an IP address and a TCP port number of the iSCSI Target and which is capable of performing, in the IP layer, communication control which reflects communication restriction in the iSCSI layer.

Then, the ACL generating program 508 adds one to the value of n (step 5086) and determines whether n is greater than the number of records on the DD list after update (step 5087). When n is greater than the number of records, the process is completed. When n is smaller than the number of records, the process returns to step 5084.

For example, when the DD list is as described above and the DD data 409 is as shown in FIG. 5, the ACL generating program 508 sets n to 2 and returns to step 5084. Here, since the DD ID indicated by the second row of records on the DD list is one, all records whose DD ID is 1 are acquired, and a new temporary ACL table 5111 is generated. The temporary ACL table 5111 in this case is shown in FIG. 17.

Further, the ACL generating program 508 generates a new ACL using the temporary ACL table 5111 and adds it to the ACL table 511.

As such, the ACL generating program 508 repeatedly performs steps 5084 to 5087 on all records of the DD data 409 to generate the ACL table 511.

An example of the ACL table 511 generated from the DD data 409 according to the above-mentioned procedure by the ACL generating program 508 is shown in FIG. 12. In the present embodiment, the ACL table 511 is stored with the second row of record whose DD ID is 1 generated when n=2 and the third row of record whose DD ID is 2 generated when n=2, in addition to the first row of record whose DD ID is 0 generated when n=1.

When the ACL table 511 is generated according to the above-mentioned procedure, the management server 500 generates a description capable of being registered as the Config information of each communication device, using the records stored in the ACL table 511 by the ACL generating program 509, and registers the description on the Config information items 209 and 229 of the respective communication devices 200 and 220. The registration is performed on communication devices (adjacent communication devices in the logical structure) having a source IP address and a destination IP address of each record of the ACL table in their interfaces.

Hereinafter, the process of the ACL setup program 509 will be described in detail. The description thereof is as follows.

The Config information and the MAC table are acquired from each communication device, and a communication device holding the Config information that has an interface including the source IP address 511b and a communication device holding the Config information that has an interface including the destination IP address 511d are specified for every ACL stored in the ACL table 511. Then, the description of the Config information in which the source IP address 511b is a source and the destination IP address 511d is a destination and the description of the Config information in which the destination IP address 511d is a source and the source IP address 511b is a destination are respectively added to the communication devices.

In the description of the present embodiment, the ACL table shown in FIG. 12 is used as the ACL table 511, and the Config information items shown in FIGS. 9 and 10 are respectively used as the Config information items 209 and 220. In addition, the MAC tables shown in FIGS. 7 and 8 are used as the MAC tables 210 and 230.

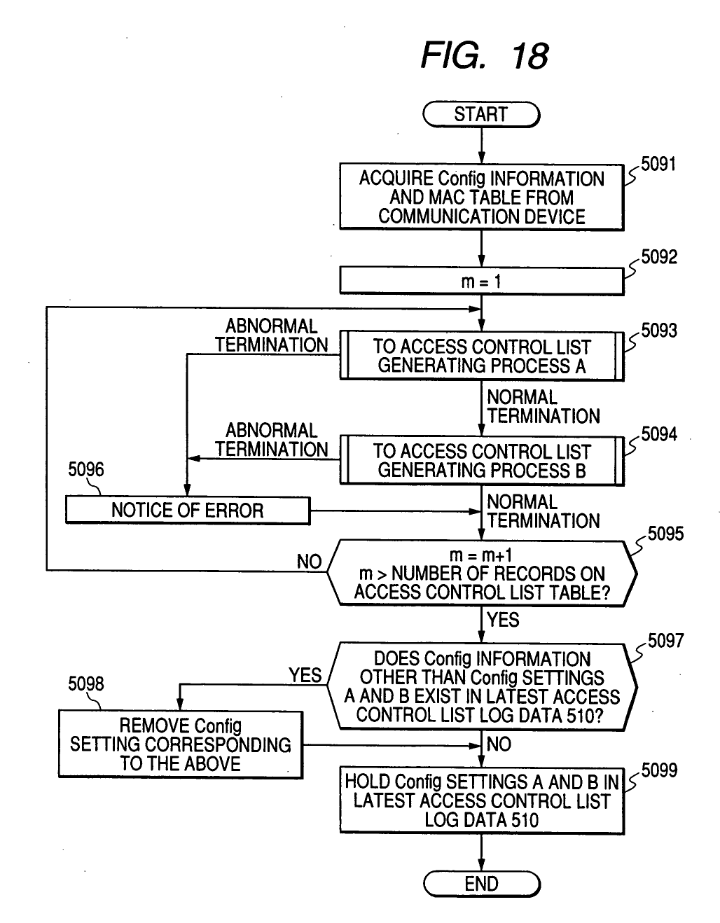

FIG. 18 is a process flow when filter setting is performed on the communication devices 200 and 220 by the ACL setup program 509.

The ACL setup program 509 acquires the Config information and the MAC table from all communication devices in the system (step 5091). In the present embodiment, the Config information items 209 and 229 and the MAC tables 210 and 230 are acquired from the communication devices 200 and 220.

Then, the ACL setup program 509 sets ‘m’ (where m is a natural number) to 1 (step 5092).

Next, as an ACL generating process A, the ACL setup program 509 specifies a communication device to be set, based on the source IP address 511b of an m-th row of records in the ACL table 511, and generates the description of the Config information to add it to the Config information of the specified communication device (step 5093). In this case, the generated description is stored as a Config setting A. The Config setting A is initialized at the time when the ACL setup program 509 starts. After that, the Config setting A is added whenever the description is generated. In an ACL generating process A, a normal termination and an abnormal termination are repeated. The ACL generating process A will be described later.

When the ACL generating process A is normally terminated, the ACL generating process B is performed (step 5094). Meanwhile, when the ACL generating process A is abnormally terminated, the notice of error is performed (step 5096) and step 5095 is performed.

As an ACL generating process B, the ACL setup program 509 specifies a communication device to be set, based on the source IP address 511d of an m-th row of records in the ACL table 511, and generates the description of the Config information to add it to the Config information of the specified communication device (step 5094). In this case, the generated description is stored as a Config setting B. The Config setting B is initialized at the time when the ACL setup program 509 starts. After that, the Config setting B is added whenever the description is generated. In an ACL generating process B, a normal termination and an abnormal termination are repeated. The ACL generating process B will be described later.

When the ACL generating process B is abnormally terminated, the notice of error is performed (step 5096), and step 5095 is then performed. When the ACL generating process B is normally terminated, step 5095 is performed.

The ACL setup program 509 adds 1 to the value of m and checks whether m is greater than the number of records in the ACL table 511 (step 5095).

When m is smaller than the number of records, the process returns to step 5093 and repeatedly performs the above-mentioned process on the next record (the second row of records) of the ACL table 511. Then, the description generated from the ACL is respectively added to the Config information items 209 and 229.

Meanwhile, in step 5095, when m is greater than the number of records, the Config setting A and the Config setting B stored at steps 5093 and 5094 is compared to the latest ACL log data 510 (step 5097).

When a description other than the Config setting A and the Config setting B is present in the latest ACL log data 510, the ACL setup program 509 specifies the Config information of a communication device having the description and removes the description (step 5098). Then, step 5099 is performed. On the other hand, when any description other than the Config setting A and the Config setting B is not present in the latest ACL log data 510, the process immediately proceeds to step 5099.

The ACL setup program 509 registers the latest Config information items 209 and 229 that are added in the ACL generating processes A and B and are then removed at step 5098 on the communication devices 200 and 220, respectively, and adds the Config setting A and the Config setting B to the ACL log data 510 (step 5099).

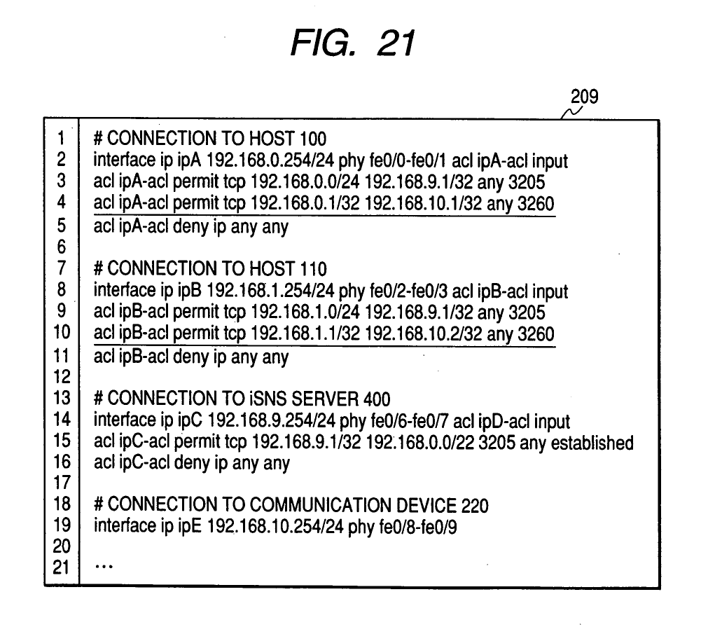

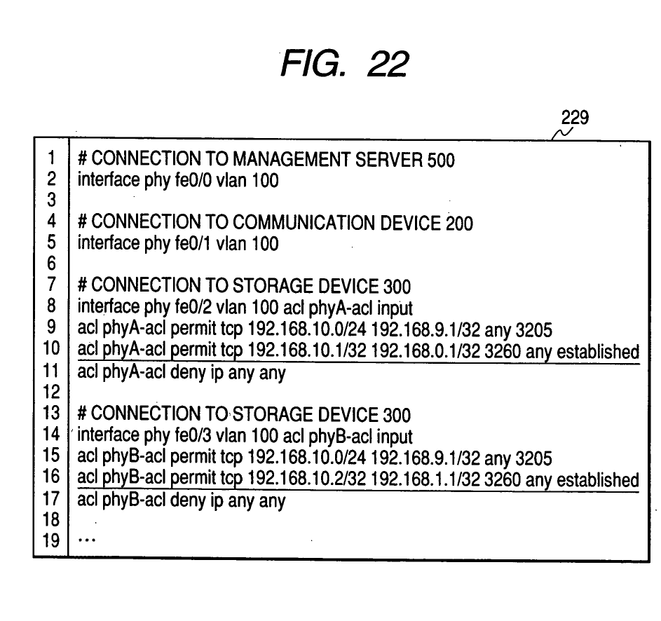

Examples of the last generated Config information items 209 and 229 are shown in FIGS. 21 and 22, respectively. In FIGS. 21 and 22, rows indicated by underlines are new-generated definitions.

Next, the ACL generating process A will be described.

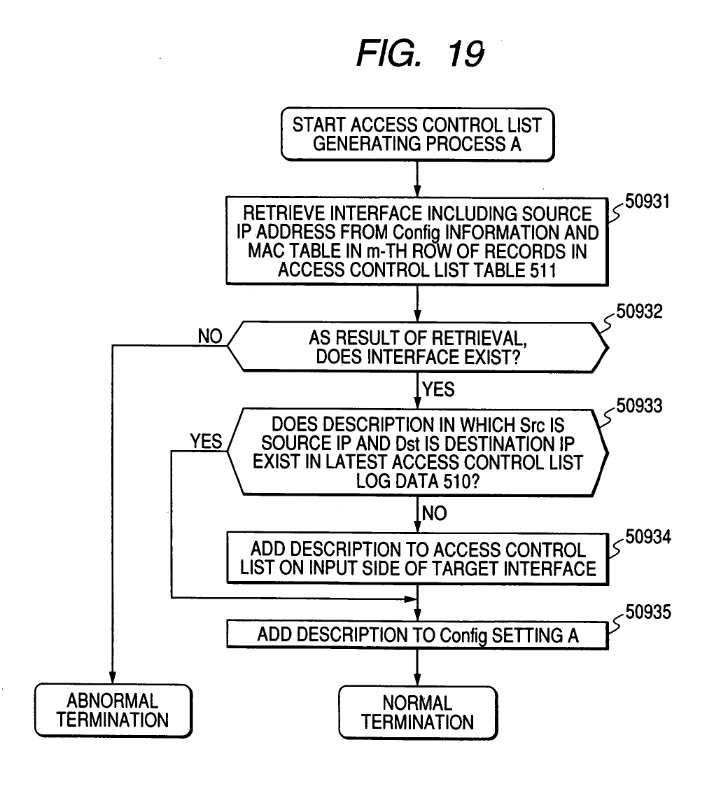

FIG. 19 shows a process flow of the ACL generating process A.

The ACL generating program 509 retrieves the MAC tables 210 and 230 and the Config information items 209 and 229. When there is an interface having the source IP address 511b of an m-th row of records in the ACL table 511 as the IP address 210b, the ACL setup program 509 extracts the interface and specifies a communication device that has extracted the interface (step 50931). This is a process to specify the communication device and interface for setting an ACL.

Here, a source IP address in a first row of the ACL table 511 is 192.168.0.1. It is specified that the IP address is accommodated in the interface ipA of the communication device 200 from the MAC table 210 and the Config information 209 shown in FIG. 7.

In the ACL setup program 509, when it is possible to be specified that an interface which is a target is accommodated in any communication device, the process proceeds to step 50933. When it is impossible to specify that, the process is abnormally terminated (step 50932).

Further, at the time of abnormal termination, the ACL with respect to the m-th row of records is not generated. In this case, an error message, such as SNMP Trap, may be noticed to an administrator 800.

When it is possible to specify that, the ACL setup program 509 generates the description of the Config information including the ACL related to a target interface on the input side and determines whether the description exists in the ACL log data 510 (step 50933).

Specifically, the description of Config information is generated, in which a source IP address is a source IP address 192.168.0.1 in the first row of the ACL table 511, a source port is a destination port ‘any’ in the first row of the ACL table 511, a destination IP address is a destination IP address 192.168.10.1 in the first row of the ACL table 511, and a destination port is a destination port 3260 in the first row of the ACL table 511.

In the case that the description of the Config information exists in the ACL log data 510, since the Config information on the description has already been set, the process proceeds to step 50935. Meanwhile, when the description does not exist in the ACL log data 510, the description of the Config information generated at step 50933 is added to the Config information 209 of the target interface (here, the interface ipA of the communication device 200) (step 50934), and then the process proceeds to step 50935.

Here, FIG. 21 shows the Config information 209 after the description of the set Config information is added. The added Config information corresponds to a fourth row of descriptions. As described above, the present process makes it possible to generate the Config information including an ACL setup of an IP packet from the iSCSI initiator to the iSCSI target.

Further, the ACL setup program 509 adds the description of the Config information generated at step 50933 to the Config setting A (step 50935), and normally terminates the process.

Next, the ACL generating process B will be described.

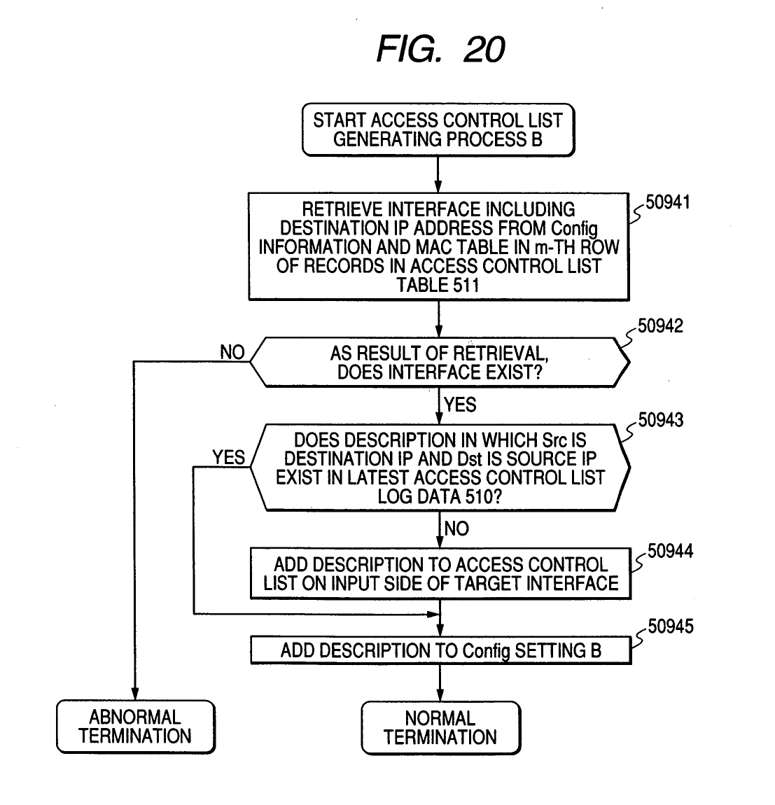

FIG. 20 shows a process flow of the ACL generating process B.

The ACL generating program 509 retrieves the MAC tables 210 and 230. When there is an interface having the destination IP address 511d of an m-th row of records in the ACL table 511 as the IP address 210b, the ACL setup program 509 extracts the interface and specifies a communication device that has extracted the interface (step 50941). This is a process to specify the communication device and interface for setting an ACL.

Here, a destination IP address in the first row of the ACL table 511 is 192.168.10.1. As the IP address, IP addresses accommodated in an interface ipE of the communication device 200 and an interface fe0/2 of the communication device 220 are specified from the MAC table 210 shown in FIG. 7 and the MAC table 230 shown in FIG. 8.

As such, in the present embodiment, two interface candidates, which are targets of the ACL, are obtained. Therefore, with reference to the Config information items 209 and 229, it is determined which interface is closer to a target destination IP address in the logical structure of an IP network.

In the present embodiment, conditions including the destination IP address 192.168.10.1 with respect to the interface ipE are described in the Config information 209 of the communication device 200, but are not described in the Config information 229 of the communication device 220. In this case, it is considered that an interface having the destination IP address 511d is connected to the communication device 200 through the communication device 220. Therefore, in this case, the communication device 220 is determined and specified as a closer communication device.

In the ACL setup program 509, when it is possible to be specified that an interface which is a target is accommodated in any communication device, the process proceeds to step 50943. When it is impossible to specify that, the process is abnormally terminated (step 50942).

Further, at the time of abnormal termination, the ACL with respect to the m-th row of records is not generated. In this case, an error message such as SNMP Trap may be noticed to the administrator 800.

When it is possible to specify that, the ACL setup program 509 generates the description of the Config information including the ACL related to a target interface on the input side and determines whether the description exists in the ACL log data 510 (step 50943).

Specifically, the description of Config information in which a source IP address is a destination IP address 192.168.10.1 in the first row of the ACL table 511, a source port is a destination port 3260 in the first row of the ACL table 511, a destination IP address is a source IP address 192.168.0.1 in the first row of the ACL table 511, and a destination port is a source port ‘any’ in the first row of the ACL table 511 is generated in the Config information 229 of a target interface (here, an interface fe0/2 of the communication device 220).

In the case that the description of the Config information exists in the ACL log data 510, since the Config information on the description has already been set, the process proceeds to step 50945. Meanwhile, when the description does not exist in the ACL log data 510, the description of the Config information generated at step 50943 is added to the Config information 229 of the target interface (here, the interface fe0/2 of the communication device 220) (step 50944), and then the process proceeds to step 50945.

FIG. 22 shows the Config information 229 after the description of the set Config information is added. The added Config information corresponds to a tenth row of description. As described above, the present process makes it possible to generate the Config information including an ACL setup of an IP packet from the iSCSI target to the iSCSI initiator.

Further, the ACL setup program 509 adds the description of the Config information generated at step 50943 to the Config setting B (setp 50945), and normally terminates the process.

The above is the description of the process of the ACL setup program 509. In the present embodiment, when the structure of a storage area network is changed by the ACL setup program 509, it is possible to perform filter setting corresponding to the changed structure on the communication device.

For example, when a new structure is added to the storage area network of the present embodiment, the DD data 409 is updated. Accordingly, the management server 500 generates an ACL from the ACL table 511 generated from the updated DD data 409 and then adds it to the Config information. Further, when the structure is separated, the DD data 409 is similarly updated, and the management server 500 generates an ACL from the generated ACL table 511 to add it to the Config information. In this case, only by setting the new-generated ACL to the Config information, the ACL related to the separated structure still remains. Therefore, as described above, a process of extracting and removing unnecessary ACLs using the ACL log data 510 is performed.

For example, in the present embodiment, when the host is separated, an IP address for accessing the host 100 is included in the ACL, and the fourth row of definitions shown in FIG. 19 and the tenth row of definitions shown in FIG. 20 are not needed. Therefore, the ACL setup program 509 of the present embodiment performs a process of removing unnecessary definitions from the previously set definitions, with reference to the ACL log data 510.

In the above-mentioned procedure, in the present embodiment, the ACL which reflects restrictions peculiar to the iSCSI communication is realized on the IP network. In this way, it is possible to restrict the communication between the iSCSI nodes that is not permitted in the iSCSI layer at the IP level and thus to improve the security level of IP-SAN.

Further, in the present embodiment, it has been described that the management server 500 holds the ACL generating program 508 and the ACL setup program 509, but the invention is not limited thereto. For example, the host 100 or 110, the storage device 300, the iSNS server 400, or the communication device 200 or 220 may hold these programs.

Furthermore, in the case of the structure in which the communication device 200 or 220 holds the ACL generating program 508 and the ACL setup program 509, in the process of the ACL setup program 509, only the ACL related to an interface held in the communication device is set in the communication device.

In the DD data 409 shown in FIG. 5, as in the records indicated in the third and fifth rows, even when the same IP address serves both as the iSCSI initiator (iqn.a.com:str-Ini) and the iSCSI target (iqn.a.com:str-LU0), it is possible to realize the setting of an ACL in the same IP layer.

As described above, according to the present embodiment, it is possible to realize filter setting on the IP network, in which restrictions peculiar to the iSCSI communication are reflected. Therefore, according to the present embodiment, it is possible to restrict unnecessary communication that is not permitted in the iSCSI communication at an IP level.

### Second Embodiment

In the first embodiment, filter setting is performed on a communication device, and the communication between the iSCSI initiator and the iSCSI target is restricted at the IP level. In the present embodiment, a case in which filter setting is performed on SCN (State Change Notification) and ESI (Entity Status Inquiry), which are messages transmitted from the iSNS server 400 to the iSCSI node, on the IP network will be described.

The SNS is a message transmitted from the iSNS server 400 to the iSCSI node when the structure of the iSCSI node in the present system, that is, the DD data 409 is changed, in order to notify the iSCSI node of the change. In addition, the ESI is a packet issued by the iSNS server 400 to monitor on/off of the iSCSI node. The reception and transmission of SCN and ESI are performed through a specific TCP port. More specifically, SCN and ESI are respectively transmitted/received through SCN Port and ESI Port shown in FIG. 5.

That is, in the present embodiment, a filter setting method at the IP level with respect to an IP packet transmitted from the iSNS server 400 to the iSCSI node will be described.

Hereinafter, a filter setting procedure with respect to SCN will be described. ESI can be performed in the same procedure.

The structure of a system according to the present embodiment is basically the same as that in the first embodiment. However, the management server 500 has an ACL generating program 508-2 instead of the ACL generating program 508.

The ACL generating program 508-2 generates the ACL table 511 according to the following sequence. Hereinafter, a case in which a process is performed using the DD data 409 shown in FIG. 5 is described.

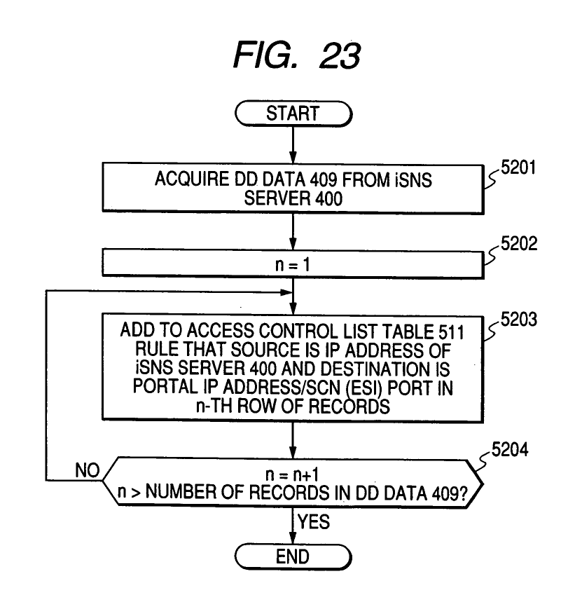

In the present embodiment, FIG. 23 shows a flow chart for generating the ACL table 511 using the ACL generating program 508-2.

The ACL generating program 508-2 acquires the DD data 409 from the iSNS server 400 (step 5201).

A count ‘n’ (where n is a natural number) is set to 1 (step 5202).

The ACL generating program 508-2 generates an ACL in which the source IP address 511b is the previously held IP address (in the present embodiment, 192.168.9.1) of the iSNS server 400, the destination IP address 511d is the Portal IP Address 409e in the n-th row of records of the DD data 409, and the destination port 511e is the SCN Port 409g in the n-th row of records of the DD data 409 (in case of ESI, ESI Port 409h), and adds it to the ACL table 511 (step 5203). Further, the IP address of the iSNS server 400 is previously set through the administrator terminal 800. In addition, in the ACL generated at step 5203, the source port 511c is set to ‘any’ because it is not particularly limited.

Next, the ACL generating program 508-2 adds 1 to the value of n and checks whether n is greater than the number of records of the DD data 409 (step 5204). When n is smaller than the number of records, the process returns to step 5203, and the above-mentioned steps are repeatedly performed.

When n is greater than the number of records, the management server 500 terminates the ACL generating program 508-2.

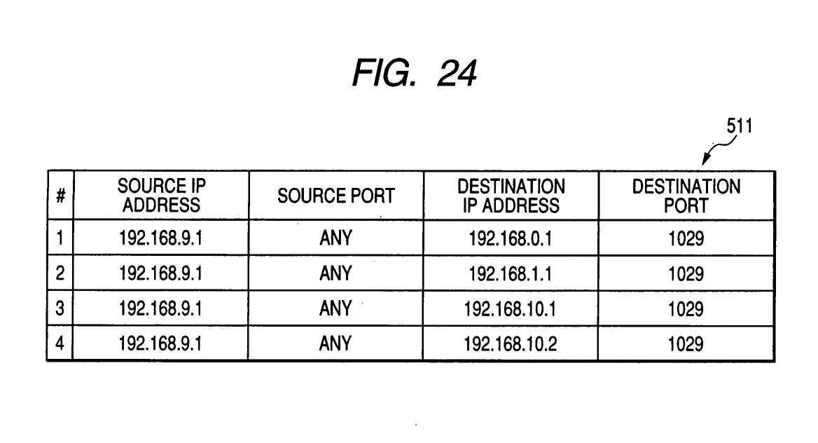

FIG. 24 shows an example of the ACL table 511 generated by the ACL generating program 508-2 according to the above-mentioned process.

When the ACL table 511 is generated in the above-mentioned procedure, the management server 500 sets the Config information 209 to a target communication device by the ACL setup program 509.

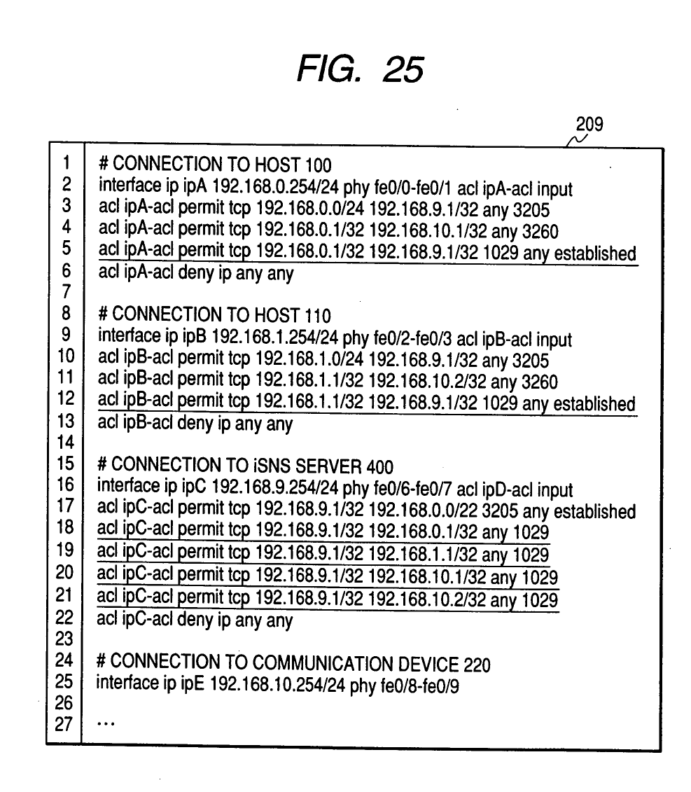

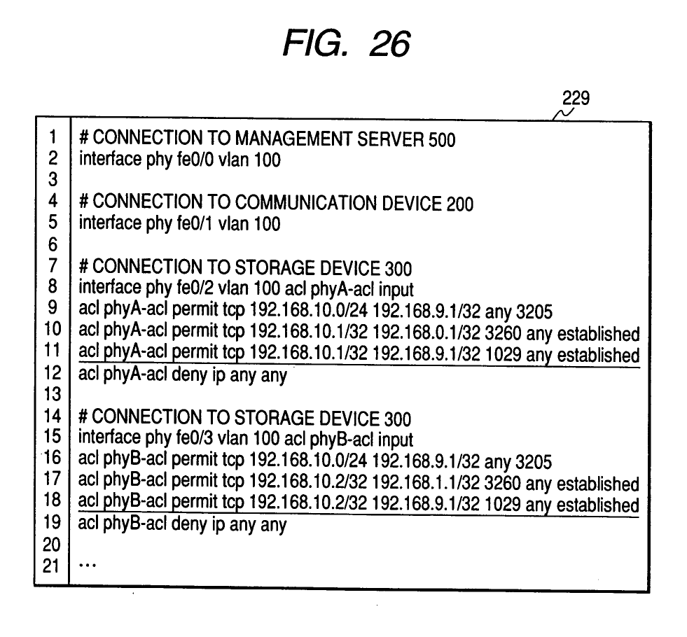

The process by the ACL setup program 509 is the same as that in the first embodiment. FIGS. 25 and 26 show the Config information items 209 and 229 generated by the ACL setup program 509 of the present embodiment, respectively. These Config information items are set in the target communication devices 200 and 220, respectively.

In the above-mentioned procedure, the ACL is realized on the IP network, in which restrictions peculiar to the iSCSI communication are reflected. In this way, it is possible to restrict IP communication that is not permitted between the iSNS server 400 and the iSCSI node, and thus it is possible to improve the security of IP-SAN.

Further, in the present embodiment, it has been described that the management server 500 holds the ACL generating program 508-2 and the ACL setup program 509, but the invention is not limited thereto. For example, the host 100 or 110, the storage device 300, the iSNS server 400, or the communication device 200 or 220 may hold these programs.

Furthermore, in case of the structure in which the communication device 200 or 220 holds the ACL generating program 508-2 and the ACL setup program 509, in the process of the ACL setup program 509, only the ACL related to an interface held in the communication device is set in the communication device.

### Third Embodiment

In the above-mentioned embodiments, based on the DD data 409 included in the iSNS server 400, the ACL table 511 is generated, and the Config information is generated. However, in the present embodiment, the above-mentioned process is realized using the path definition 313 included in the storage device 300, instead of the DD data 409.

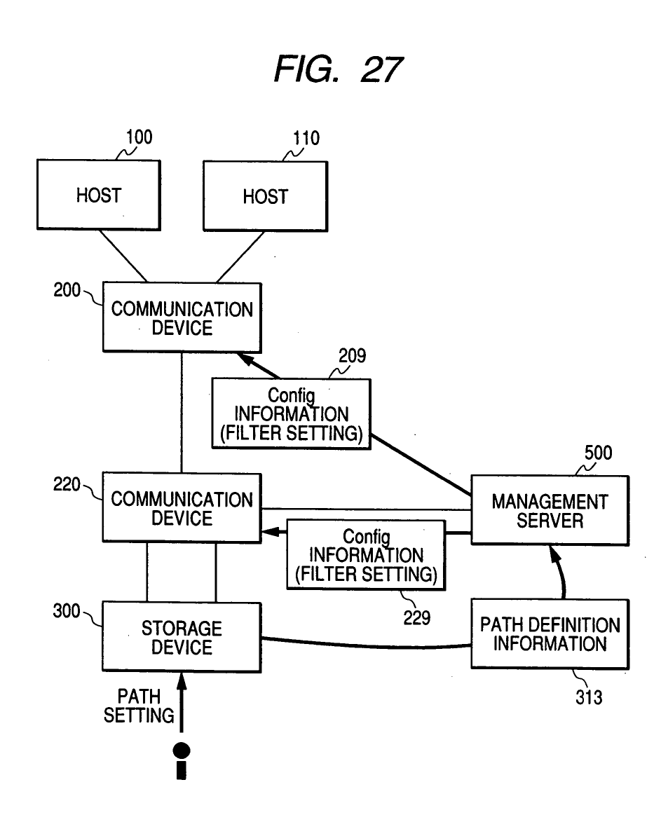

FIG. 27 is a block diagram showing the overall structure of a storage area network according to the present embodiment.

As shown in FIG. 27, in the present embodiment, the iSNS server 400 is not needed unlike the system structures of the above-mentioned embodiments. The structures of the other components are the same as those in the first embodiment. In the present embodiment, the management server 500 has an ACL generating program 508-3 instead of the ACL generating programs 508 and 508-2. Further, the ACL generating program 508-3 acquires the path definition 313 from the storage device 300 through the communication devices 200 and 220 to generate the ACL table 511.

The management server 500 performs the filter setting of the IP packet on a necessary communication device by the ACL setup program 509, using the generated ACL table 511, similar to the above-mentioned embodiments.

The path definition 313 is a table for describing the connection relationship between the iSCSI initiator and the iSCSI target, and is previously set in the storage device 300 through the administrator terminal 800. The setting method is not limited thereto.

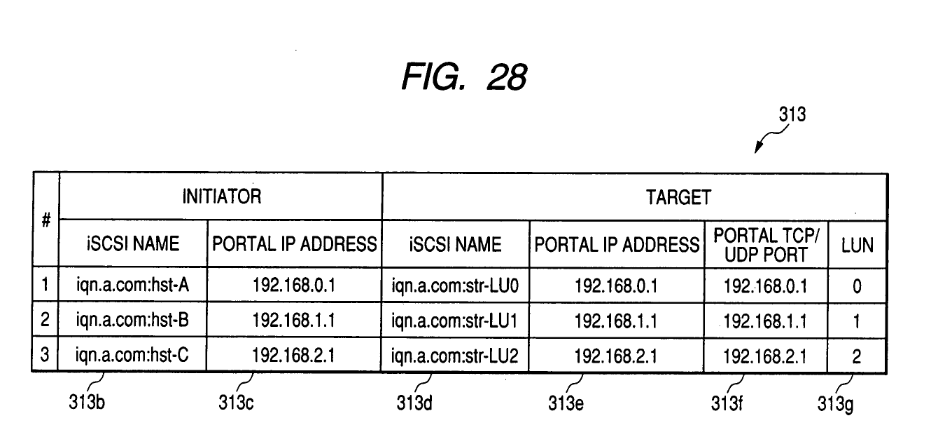

FIG. 28 shows an example of the path definition 313. As shown in FIG. 28, the path definition 313 has iSCSI Name 313b and Portal IP Address 313c for identifying an iSCSI initiator of a source, iSCSI Name 313d and Portal IP Address 313e for identifying an iSCSI target of a destination, Portal TCP/UDP Port 313f, and LUN (LU Number) 313g accessible from the iSCSI target.

In the storage device 300, the storage control device 301 controls iSCSI communication at an iSCSI layer level, based on the path definition 313. For example, the storage control device 301 performs control such that an access from iqn.a.com:hst-A to iqn.a.com:str-LU1 is not permitted by iSCSI login certification since there is no record satisfying that iSCSI Name 313b is iqn.a.com:hst-A and iSCSI Name 313d is iqn.a.com:str-LU1.

Next, it will be described a procedure for generating the ACL table 511 stored with an ACL of an IP layer, that is, an ACL in which a source is an IP address of an iSCSI initiator and a destination is a TCP/UDP port number and an IP address of an iSCSI target, from the acquired path definition 313 by the ACL generating program 508-3. In the present embodiment, a case in which a process is performed using the path definition 313 shown in FIG. 28 will be described as an example.

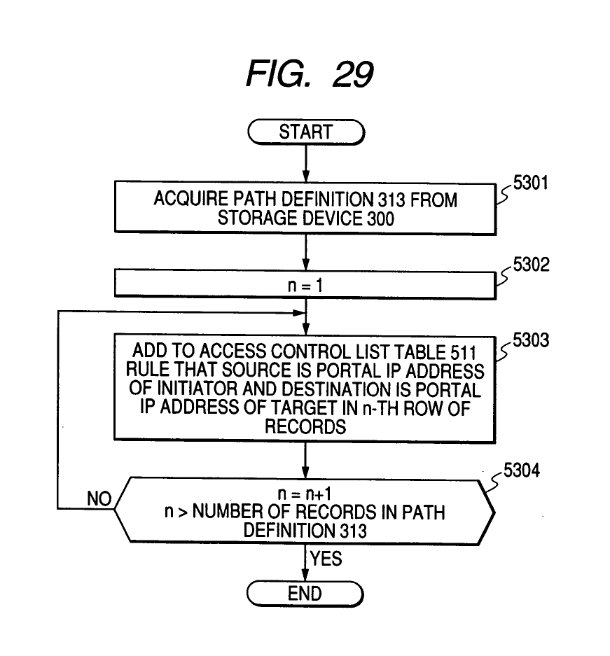

FIG. 29 is a flow chart for generating the ACL table 511 by the ACL generating program 508-3 in the present embodiment.

The ACL generating program 508-3 acquires the path definition 313 from the storage device 300 (step 5301). It is possible to acquire the path definition 313 using the conventional technique, such as SNMP Trap.

A count ‘n’ (where n is a natural number) is set to 1 (step 5302).

The ACL generating program 508-3 generates an ACL in which the source IP address 511b is an IP address of an iSCSI initiator, the destination IP address 511d is an IP address of an iSCSI target, and the destination port 511e is a TCP/UDP port, with respect to then-throw of records of the acquired path definition 313, and adds it to the ACL table 511 (step 5303). In addition, in the ACL generated at step 5303, the source port 511c is set to ‘any’ because it is not particularly limited.

In the present embodiment, the ACL table 511 in which Portal IP Address in a field ‘Initiator’ is a source and Portal IP Address and Portal TCP/UDP Port in a field ‘Target’ are destinations is generated using the first row of records of the path definition 313. An example of the ACL table generated at that time is shown in FIG. 16.

Next, the ACL generating program 508-3 adds 1 to the value of n and checks whether n is greater than the number of records of the path definition 313 (step 5304). When n is smaller than the number of records, the process returns to step 5303, and the above-mentioned steps are repeatedly performed.

When n is greater than the number of records, the management server 500 terminates the ACL generating program 508-3.

The ACL generating program 508-3 generates the ACL table 511 according to the above-mentioned process. The ACL table 511 generated in the present embodiment is the same as that in the first embodiment shown in FIG. 12.

When the ACL table 511 is generated in the above-mentioned procedure, the management server 500 sets the Config information in a target communication device by the ACL setup program 509.

The process by the ACL setup program 509 is the same as that in the first embodiment. The Config information items 209 and 229 generated in the present embodiment are the same as those in the first embodiment shown in FIGS. 21 and 22. These Config information items are set in the target communication devices 200 and 220, respectively.

In the above-mentioned procedure, according to the present embodiment, the ACL in which restrictions peculiar to the iSCSI communication is reflected is realized on the IP network without the iSNS server. In this way, it is possible to restrict IP communication that is not permitted between the iSCSI nodes at an IP layer level, and thus it is possible to improve the security of IP-SAN.

Further, in the present embodiment, the structure in which the storage device 300 has the path definition 313 has been described, but the invention is not limited thereto. That is, even when the management server 500 or the host 100 or 110 has the path definition 313, it is possible to obtain the same effects. In addition, when the host 100 and 110 has the path definition 313, the host has only the path definition related to its own device.

Furthermore, in the present embodiment, the structure in which the management server 500 has the ACL generating program 508-3 and the ACL setup program 509 has been described, but the invention is not limited thereto. For example, the host 100 or 110, the storage device 300, and the communication device 200 or 220 may have these programs.

Moreover, when the communication device 200 or 220 has the ACL generating program 508-3 and the ACL setup program 509, in the process of the ACL setup program 509, only the ACL related to an interface held in the communication device is set in the communication device.

What is claimed is:

1. A method of generating an access control list (ACL) for filtering, in each communication device, IP packets transmitted/received between iSCSI (Internet Small Computer Interface) nodes in a storage area network in which iSCSI communication between the iSCSI nodes is restricted within predetermined groups, the storage area network having iSCSI node groups each connected to an IP network through the communication device to perform the iSCSI communication, the method comprising:
a step of acquiring management information for managing by associating, for every iSCSI node, a type of the iSCSI node indicating whether the iSCSI node is an initiator or a target, an IP address and a port number allocated to the iSCSI node, and an identifier of the group to which the iSCSI node belongs; and
a step of generating, for every group, the ACL in which the IP address of an iSCSI node whose type is an iSCSI initiator is a source IP address and in which the IP address and port number of an iSCSI node whose type is the iSCSI target are a destination IP address and a destination port number.

2. A method of generating an ACL for filtering, in each communication device, a structure change notifying packet transmitted from a server for managing a change in structure of an iSCSI (Internet Small Computer Interface) node when a structure of the iSCSI node is changed in a storage area network having iSCSI node groups each connected to an IP network through the communication device to perform iSCSI communication, the method comprising:
a step of acquiring management information for managing by associating, for every iSCSI node, an IP address allocated to the iSCSI node and a port number allocated to the structure change notifying packet; and
a step of generating, for every iSCSI node, the ACL in which the IP address allocated to the server is a source IP address and in which the IP address allocated to the iSCSI node and the port number allocated to the structure change notifying packet are a destination IP address and a destination port number, respectively.

3. A method of generating an ACL for filtering, in each communication device, IP packets transmitted/received between iSCSI (Internet Small Computer Interface) nodes in a storage area network in which combinations of iSCSI nodes where iSCSI communication is permitted are predetermined, the storage area network having iSCSI node groups each connected to an IP network through the communication device to perform the iSCSI communication, the method comprising:
a step of acquiring management information for managing by associating an IP address allocated to the iSCSI node on an iSCSI initiator side of each combination of the iSCSI nodes where iSCSI communication is permitted with an IP address and a port number allocated to the iSCSI node on an iSCSI target side; and
a step of generating, for every combination, the ACL in which the IP address allocated to the iSCSI initiator is a source IP address, and the IP address and the port number allocated to the iSCSI target are a destination IP address and a destination port number, respectively.

4. An ACL setup method for setting, in a storage area network having iSCSI node groups each connected to an IP network through a communication device to perform iSCSI communication, the ACL generated by the ACL generating method according to any one of claims 1 to 3 in the respective communication devices, the method comprising:
an ACL setup step of setting the generated ACL in the communication device closest to the iSCSI node to which the source IP address is allocated from the viewpoint of a logical structure, among the communication devices managing by associating the source IP address with a MAC (Media Access Control) address, and of setting the ACL that a destination and a source of the generated ACL are reversed in the communication device closest to the iSCSI node to which the destination IP address is allocated from the viewpoint of the logical structure, among the communication devices managing by associating the destination IP address with the MAC address.

5. An access control list (ACL) generating apparatus for generating an ACL for filtering, in each communication device, IP packets transmitted/received between iSCSI (Internet Small Computer Interface) nodes in a storage area network in which iSCSI communication between the iSCSI nodes is restricted within predetermined groups, the storage area network having iSCSI node groups each connected to an IP network through the communication device to perform the iSCSI communication, the apparatus comprising:
a management information acquiring means for acquiring by associating, for every iSCSI node, management information for managing the type of iSCSI node indicating whether the iSCSI node is an initiator or a target, an IP address and a port number allocated to the iSCSI node, and an identifier of the group to which the iSCSI node belongs; and
an ACL generating means for generating, for every group, the ACL in which the IP address of an iSCSI node whose type is the iSCSI initiator is a source IP address and in which the IP address and port number of another iSCSI node whose type is the iSCSI target are a destination IP address and a destination port number, respectively.

6. An ACL generating apparatus of generating an ACL for filtering, in each communication device, a structure change notifying packet transmitted from a server for managing a change in structure of an iSCSI (Internet Small Computer Interface) node when a structure of the iSCSI node is changed in a storage area network having iSCSI node groups each connected to an IP network through the communication device to perform iSCSI communication, the apparatus comprising:
a management information acquiring means for acquiring by associating, for every iSCSI node, management information for managing an IP address allocated to the iSCSI node and a port number allocated to the structure change notifying packet; and
an ACL generating means for generating, for every iSCSI node, the ACL in which the IP address allocated to the server is a source IP address and in which the IP address allocated to the iSCSI node and the port number allocated to the structure change notifying packet are a destination IP address and a destination port number, respectively.

7. An ACL generating apparatus of generating an ACL for filtering, in each communication device, IP packets transmitted/received between iSCSI (Internet Small Computer Interface) nodes in a storage area network in which combinations of the iSCSI nodes where iSCSI communication is permitted are predetermined, the storage area network having iSCSI node groups each connected to an IP network through the communication device to perform the iSCSI communication, the apparatus comprising:
a management information acquiring means for acquiring management information for managing associating an IP address allocated to the iSCSI node on an iSCSI initiator side of each combination of the iSCSI nodes where iSCSI communication is permitted with an IP address and a port number allocated to the iSCSI node on an iSCSI target side; and
an ACL generating means for generating, for every combination, the ACL in which the IP address allocated to the iSCSI initiator is a source IP address and in which the IP address and the port number allocated to the iSCSI target are a destination IP address and a destination port number, respectively.

8. An ACL setup apparatus for setting, in a storage area network having iSCSI node groups each connected to an IP network through a communication device to perform iSCSI communication, the ACL generated by the ACL generating apparatus according to any one of claims 5 to 7 in the respective communication devices, the apparatus comprising:
an ACL setup means for setting the generated ACL in the communication device closest to the iSCSI node to which the source IP address is allocated from the viewpoint of a logical structure, among the communication devices managing by associating the source IP address with a MAC (Media Access Control) address, and for setting the ACL that a destination and a source of the generated ACL are reversed in the communication device closest to the iSCSI node to which the destination IP address is allocated from the viewpoint of the logical structure, among the communication devices managing by associating the destination IP address with the MAC address.

9. A storage area network having a host serving as an iSCSI initiator, a storage device serving as an iSCSI target, an iSNS server, a management server, a first communication device connected to the host, and a second communication device connected to the storage device, these devices being connected to an IP network,
wherein the host accesses the storage device through the first and second communication devices,
the iSNS server has discovery domain information for managing an IP address and a port number respectively allocated to the iSCSI initiator and the iSCSI target and for managing identifiers for specifying groups including the iSCSI initiator and the iSCSI target, and when receiving an inquiry about an accessible iSCSI target from the iSCSI initiator, the iSNS server transmits the iSCSI target belonging to the same group of the iSCSI initiator of an inquiry source in response to the inquiry, the management server comprises:
an ACL generating means for, when the discovery domain information is changed, acquiring the discovery domain information from the iSNS server and for generating, for every group, an ACL in which the IP address allocated to the iSCSI initiator is a source IP address and in which the IP address and port number allocated to the iSCSI target are a destination address and a destination port number, respectively; and
an ACL setup means for setting the generated ACL in the communication device closest to the iSCSI node to which the source IP address is allocated from the viewpoint of a logical structure, among the communication devices managing by associating the source IP address with a MAC (Media Access Control) address, and for setting the ACL that a destination and a source of the generated ACL are reversed in the communication device closest to the iSCSI node to which the destination IP address is allocated from the viewpoint of the logical structure, among the communication devices managing by associating the destination IP address and the MAC address.
